(19) United States
(12) Patent Application Publication
(10) Pub. No.: US 2008/0233957 A1
(43) Pub. Date: Sep. 25, 2008

(54) Profile information synchronization system, profile information synchronization method, mobile terminal device and profile information synchronization server

(75) Inventor: Katsuaki AKAMA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/046,899

(22) Filed: Mar. 12, 2008

(30) Foreign Application Priority Data
Mar. 19, 2007 (JP) 2007-69848

(51) Int. Cl. H04Q 7/20; H04M 1/00

(52) U.S. Cl. 455/435.1; 455/550.1

(57) ABSTRACT

Profile information of mobile terminal devices of users is synchronized by transmitting profile information of a user of a mobile terminal device along with a group identification information to a profile information synchronization server, registering by the server received profile information in correspondence with received group identification information, based upon the transmitting, extracting by the server one or more of the profile information managed based upon the received group identification information of the group to which the user of the terminal device belongs including new profile information that the terminal device has not recorded and transmitting the extracted profile information to the terminal device. The terminal device obtains the profile information of the group to which the user of the terminal device belongs including the new profile information that the terminal device itself has not recorded, from the server based upon the group identification information.

### CROSS-REFERENCE TO RELATED APPLICATIONS

This application is related to and claims priority to Japanese patent application no. 2007-069848 filed on Mar. 19, 2007 in the Japan Patent Office, and incorporated by reference herein.

### BACKGROUND

1. Field

The embodiments relate to a technology for exchanging profile information between mobile phones. More particularly, the embodiments relate to a profile information synchronization system, a profile information synchronization method, a mobile terminal device and a profile synchronization server which enable all of members of a group to easily obtain the profile information of all of the group members.

2. Description of the Related Art

When there is a gathering for some purpose, participants exchange profile information with each other. In this case, the profile information includes personal information such as a name, a phone number, a mail address, a company name, a department name and a professional skill.

For example, in case a project team is formed when a project starts, members of the project team might meet each other for the first time. In this case, the members of the project team need to exchange the phone numbers and the like.

Exchanging name card is the most common way to exchange phone numbers and the like between the members. A name card contains a name, a phone number, a mail address, a belonging group and the like. In this case, each of the members registers, with the mobile terminal device by hand, the name, the phone number, the mail address and the like written on the name card received from the other member.

As another way to exchange phone numbers and the like, there is a means for making a name list containing names, phone numbers, mail addresses, belonging groups and the like of all the members of the project team and for distributing the name lists to each of the members. Even in this case, each of the members needs to register the name, the phone number, the mail address and the like with the mobile phone by hand (manual input).

In this case, however, there is a problem that it takes a lot of trouble to register the information, one by one, with the mobile phone by hand and more input mistakes occur. In case of exchanging name card, the name cards need to be filed. Nowadays, name lists tend not to be made because of the problem related to handling the personal information.

Recently, there has been a means for exchanging profile information such as a phone number and a mail address by one-to-one infrared communication between a mobile device and a server. In this case, there are less trouble and fewer input mistakes because there is no need to register the profile information by hand.

For example, Japanese Laid-Open Patent Publication no. 2006-059239 discloses the technology for using a personal information exchange supporting terminal as a file server in order to register the information with the file server from each of the mobile phones and to make the information referable by all of the mobile phones. Then, a relationship between individuals who want to exchange the information is recorded and information is transferred via a mail based on the information.

Unlike exchanging name card, the above-described one-to-one infrared communication with the server has an advantage that it takes less trouble to register the information with the mobile phone. However, it takes some trouble and time to exchange the profile information with all of the team members one by one via the server. In order to exchange the profile information with the team members of the number of N, the number of times N×(N−1) of one-to-one infrared communication with the server is required, so that it takes huge amounts of time and trouble if the number of the team members increase.

When all of the team members try to exchange the profile information with each other, if the members exchange the profile information individually one by one via the server, it can take a long time to exchange the profile information of all of the members or some of the members may forget to exchange one or more of the profile information. As a result, the members may have discrete profile information which is not uniform.

The above-disclosed technology of the Japanese Laid-Open Patent Publication no. 2006-059239 makes it possible to exchange the profile information by the mobile phone. However, there is a problem that more user operation, such as selecting information and requesting to obtain information is necessary, because there is no user/member group management. For example, the above-disclosed technology of the Japanese Laid-Open Patent Publication no. 2006-059239 does not consider that the mobile terminal devices of all of the group members synchronize the profile information of the group members. Therefore, in order to synchronize the profile information which the mobile terminal devices of all of the group members have by using the above-disclosed technology of the Japanese Laid-Open Patent Publication no. 2006-059239, all of the group members have to specify all of the group members one by one as members who exchange the profile information with themselves, which is not easily realized.

### SUMMARY

In an unlimiting example, according to an aspect of the embodiments, the above-mentioned example problems in the conventional technology are overcome. According to an aspect of an embodiment, the technology is provided with an example purpose of solving the above-described example problems, namely simplifying the operation of the mobile terminal device for exchanging the profile information between the group members, and also for synchronizing the profile information which the mobile terminal devices of all the group members have.

According to an aspect of an embodiment, profile information of mobile terminal devices of users is synchronized by transmitting profile information of a user of a mobile terminal device along with a group identification information to a profile information synchronization server, registering by the profile information synchronization server received profile information in correspondence with received group identification information, based upon the transmitting, extracting by the profile information synchronization server one or more of the profile information managed based upon the received group identification information of the group to which the user of the mobile terminal device belongs including new profile information that the mobile terminal device has not recorded and transmitting the extracted profile information to the mobile terminal device. The mobile terminal device obtains the profile information of the group to which the user of the mobile terminal device belongs including the new profile information that the mobile terminal device itself has not recorded, from the profile information synchronization server based upon the group identification information.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram explaining a concept of an embodiment.

FIG. 2 is a diagram showing a configuration example of a profile information synchronization system of one embodiment.

FIG. 3 is a diagram explaining an example of a profile information recording unit.

FIG. 4 is a diagram explaining an example of a profile information management table and a profile information storage unit.

FIG. 5 is a flow chart of group registration processing by a mobile terminal device.

FIG. 6 is a flow chart of group definition processing by a profile information synchronization server.

FIG. 7 is a flow chart of profile information registration processing by a mobile terminal device.

FIG. 8 is a flow chart of profile information storage processing by a profile information synchronization server.

FIG. 9 is a flow chart of profile information obtaining processing by a mobile terminal device.

FIG. 10 is a flow chart of profile information synchronization processing by a profile information synchronization server.

FIG. 11 is a diagram (1) explaining a concrete example.

FIG. 12 is a diagram (2) explaining a concrete example.

FIG. 13 is a diagram (3) explaining a concrete example.

FIG. 14 is a diagram (4) explaining a concrete example.

### DETAILED DESCRIPTION OF THE PREFERRED EMBODIMENTS

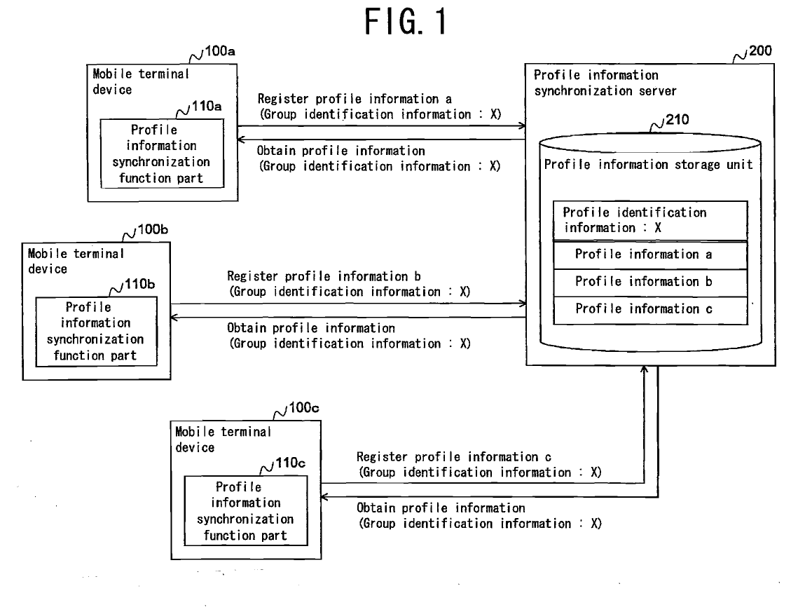

FIG. 1 is a diagram explaining a concept of one embodiment. The diagram explains that members of a group comprise three members exchanging profile information with each other by using a mobile terminal device 100(a, b, c). Each of the mobile terminal devices 100 is provided with a profile information synchronization function part 110(a, b, c) for exchanging the profile information. A profile information synchronization server 200 is a server for managing exchange of the profile information, and is provided with a profile information storage unit 210 storing the registered profile information.

Firstly, a representative member of the group obtains group identification information which is used to uniquely identify the group (figure omitted). In this case, it is assumes that X is obtained as the group identification information. The representative member of the group notifies the other members of the obtained group identification information X.

Each of the group members activates the profile information synchronization function part 110 in his/her mobile terminal device 100 in order to register own profile information. That is, a mobile terminal device 100a transmits profile information a, and a mobile terminal device 100b transmits profile information b, and a mobile terminal device 100c transmits profile information c to the profile information synchronization server 200. At this time, the profile information is added with the group identification information X.

The profile information synchronization server 200 manages the profile information registered for each of the group identification information. That is, the profile information a, the profile information b and the profile information c are stored as the profile information of the group identification information X in the profile information storage unit 210.

In order to obtain the registered profile information, each of the mobile terminal devices 100 accesses the profile information synchronization server 200 by the group identification information. That is, when each of the mobile terminal devices 100 accesses the profile information synchronization server 200 by the group identification information X, the profile information a, the profile information b and the profile information c are extracted by the profile information synchronization server 200 and are transmitted to each of the mobile terminal devices 100.

Due to this, instead of exchanging the profile information one by one, it is possible to exchange the profile information of one or more, for example, all of the group members, when the member registers his/her own profile information with the profile information synchronization server 200 by using the group identification information and obtains the profile information of the group members from profile information synchronization server 200 by using the group identification information. Since registration and obtainment of the profile information are synchronized for each group, all of the group members have the same profile information and do not forget to exchange the profile information of the certain members.

When the group is disbanded, all of the profile information registered with the profile information synchronization server 200 can be deleted collectively if the representative member of the group transmits a batch delete command to the profile information synchronization server 200.

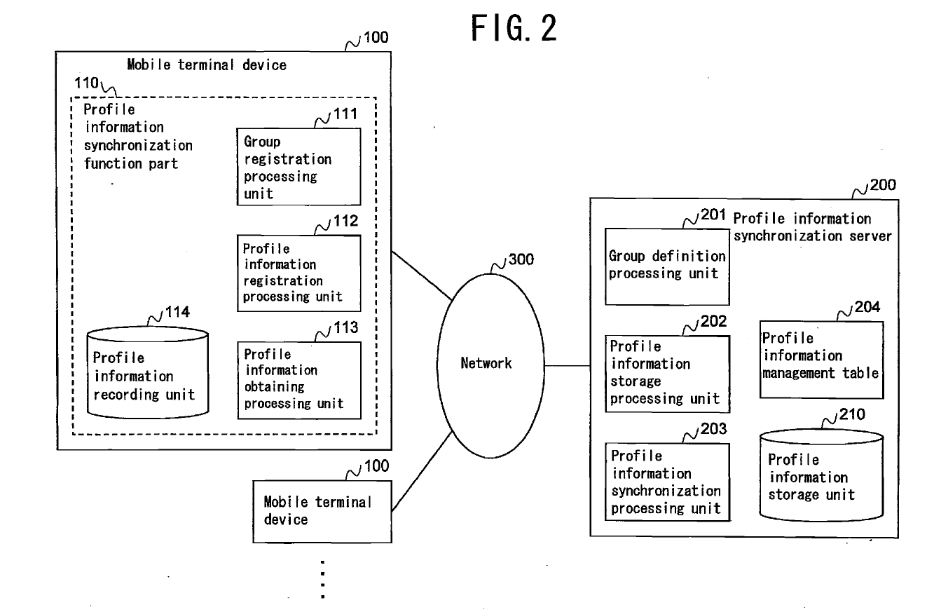

FIG. 2 is a diagram showing a configuration example of the profile information synchronization system according to one embodiment. In the profile information synchronization system shown in FIG. 2, each of the mobile terminal devices 100 can be communicated with the profile information synchronization server 200 through a communication network 300.

The mobile terminal device 100 is provided with the profile information synchronization function part 110. The profile information synchronization function part 110 is realized by an application software or the like and can be activated by operating a menu screen of the mobile terminal device 100.

The profile information synchronization function part of the mobile terminal device 100 includes a group registration processing unit 111, a profile information registration processing unit 112, a profile information obtaining processing unit 113 and a profile information recording unit 114.

The group registration processing unit 111 is a registration unit performing registration processing of a new group to the profile information synchronization server 200 and obtaining the group identification (ID). The group ID corresponds to the above-described group identification information. The group registration processing unit 111 transmits a registration request of the new group to the profile information synchronization server 200 and receives the group ID allocated by the profile information synchronization server 200. A user of the mobile terminal device 100 can input the group ID which the user wants and permission for the use of the inputted group ID by the profile information synchronization server 200 may be requested.

The profile information registration processing unit 112 is a registration unit registering own profile information with the profile information synchronization server 200. The own profile information is the profile information of the user using the mobile terminal device 100. The profile information registration processing unit 112 makes the user of the mobile terminal device 100 input the group ID and transmits the own profile information with the inputted group ID to the profile information synchronization server 200. The own profile information can be registered in advance by the mobile terminal device 100 or can be inputted by the user at the time of the profile information registration processing.

The profile information obtaining processing unit 113 is an obtaining unit obtaining the profile information registered with the profile information synchronization server 200. The profile information obtaining processing unit 113 accesses the profile information synchronization server 200 by the group ID and obtains the profile information which has not been obtained by the own mobile terminal device 100 out of the profile information registered with the profile information synchronization server 200 by the group ID. According to an aspect of an embodiment, existing profile information of member of the group at the mobile terminal device can also be updated.

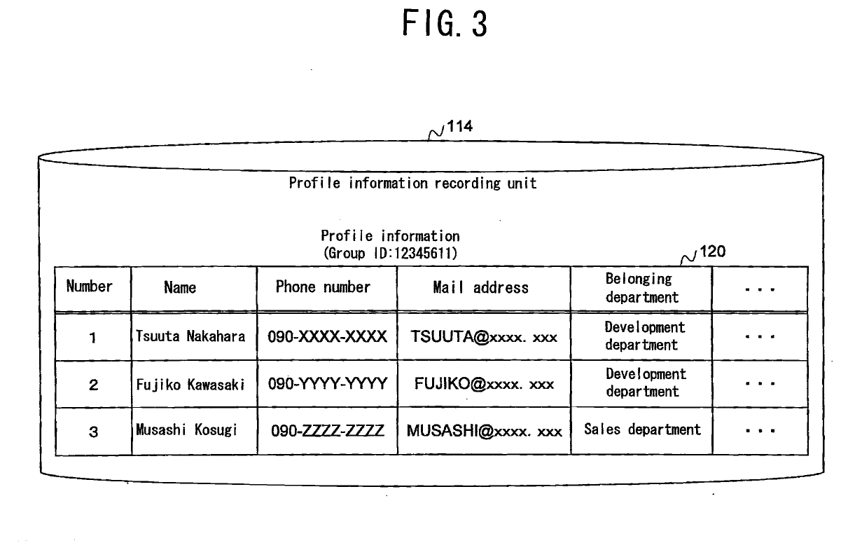

FIG. 3 is a diagram explaining an example of the profile information recording unit. The profile information recording unit 114 records the profile information obtained from the profile information synchronization server 200 by the profile information obtaining processing unit 113. The profile information recorded in the profile information recording unit 114 is managed by the group ID.

FIG. 3 shows an example showing that profile information 120 of a group ID “12345611” is recorded in the profile information recording unit 114. The profile information 120 of the group ID “12345611” shown in FIG. 3 includes a phone number, a name, a phone number, a mail address, a belonging group and the like. In this case, three of the profile information are recorded as the profile information 120 of the group ID “12345611”.

For example, in case the mobile terminal device 100 is a mobile phone and the like, the profile information recorded in the profile information recording unit 114 can be browsed like a phone book function of the mobile phone in order to use the phone number, the mail address and the like. That is, it is possible to call up the phone number or the mail address from the profile information recorded in the profile information recording unit 114 in order to make a call or send a mail.

Also, the profile information recording unit 114 can be part of the phone book function. That is, the obtained profile information can be added with the group ID and be registered with the phone book function of the mobile phone or the like.

In FIG. 2, the profile information synchronization server 200 includes a group definition processing unit 201, a profile information storage processing unit 202, a profile information synchronization processing unit 203, a profile information management table 204 and a profile information storage unit 210.

The group definition processing unit 201 is a defining unit for defining the group by the registration request of the new group transmitted from the mobile terminal device 100. When receiving the registration request of the group from the mobile terminal device 100, the group definition processing unit 201 generates/defines the group ID which is to be allocated to the group, and transmits the group ID to the mobile terminal device 100 and ensures an area for storing the profile information of the group in the profile information storage unit 210. If the desired group ID is transmitted from the mobile terminal device 100, the group definition processing unit 201 determines whether or not the group ID has already been used. The group ID is defined if the group ID is usable.

The profile information storage processing unit 202 is a storage unit for storing the profile information transmitted from the mobile terminal device 100 in the profile information storage unit 210. The profile information storage processing unit 202 searches the profile information management table 204 by the group ID transmitted with the profile information, specifies a storage area of the profile information storage unit 210 and stores the transmitted profile information in the specified storage area of the profile information storage unit 210.

The profile information synchronization processing unit 203 is a transmitting unit for transmitting the profile information stored in the profile information storage unit 210 to the mobile terminal device 100. When receiving an inquiry from the mobile terminal device 100 by the group ID, the profile information synchronization processing unit 203 searches the profile information management table 204 in order to specify the storage area of the profile information storage unit 210. For example, the profile information synchronization processing unit 203 extracts the profile information which has not been registered by the mobile terminal device 100 performing the inquiry by the group ID out of the profile information stored in the specified storage area of the profile information storage unit 210, and transmits the extracted profile information to the mobile terminal device 100.

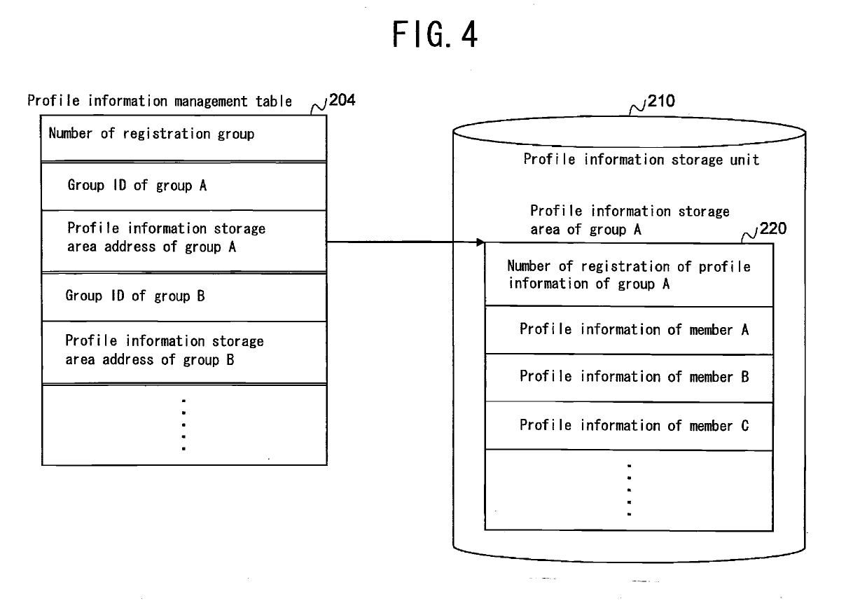

FIG. 4 is a diagram explaining an example of the profile information management table and the profile information storage unit. The profile information management table 204 is a table for managing a storage state of the profile information registered with the profile information storage unit 210. The profile information storage unit 210 is a storage unit for storing the registered profile information.

The profile information management table 204 has a number of the registration group and corresponding information of the group ID and the profile information storage area address for each of the groups. The number of the registration group is the number of the group registered in the profile information synchronization server 200. The group ID is the identification information which is defined by the group. The profile information storage area address is the address of the profile information storage unit 210 in which the profile information of the group is stored. The profile information management table 204 manages the corresponding information of the group ID and the profile information storage area addresses of the number of the registration group.

The profile information storage unit 210 is provided with a profile information storage area 220 for each of the groups. The profile information storage area 220 stores the number of the profile information registration and each of the profile information. The number of the profile information registration is the number of registrants of profile information for the group. The profile information storage area 220 stores the profile information of the number of registration of the profile information.

As shown in FIG. 4, for example, by receiving the group ID for a group A, it is possible to obtain the profile information storage address of the group A in the profile information management table 204. It is possible to store the profile information of the group A and extract the profile information of the group A by accessing the profile information storage area 220 by the obtained profile information storage area address of the group A.

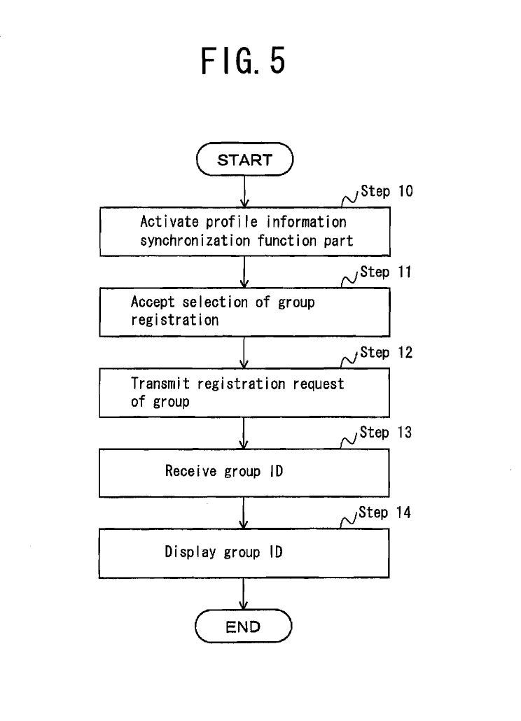

FIG. 5 is a flow chart of group registration processing by the mobile terminal device. If the representative member of the group selects the profile information synchronization function part 110 from the menu screen of his/her mobile terminal device 100, the mobile terminal device 100 activates the profile information synchronization function part 110 (Step 10). Then, when accepting the selection of the group registration made by the representative member from the profile information synchronization menu (Step 11), the mobile terminal device 100 transmits the registration request of the group to the profile information synchronization server 200 (Step 12).

When the group ID is received from the profile information synchronization server 200 (Step 13), the received group ID is displayed in the screen of the mobile terminal device 100 (Step 14). The representative member of the group notifies the other group members of the group ID displayed in the screen of the mobile terminal device 100.

The representative member of the group can input the group ID which he/she wants. In this case, when the selection of the group registration made by the representative member is accepted in Step 11, an input screen for the desired group ID is displayed in the screen of the mobile terminal device 100. The inputted group ID is transmitted with the registration request of the group to the profile information synchronization server 200 and an availability of the group ID is transmitted back to the mobile terminal device 100.

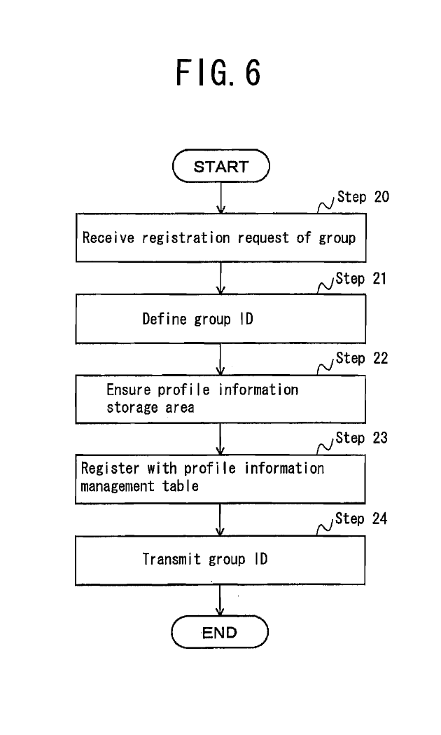

FIG. 6 is a flow chart of group definition processing by the profile information synchronization server. When receiving the registration request of the group from the mobile terminal device 100 (Step 20), the profile information synchronization server 200 defines the group ID (Step 21). In a definition of the group ID, a group ID that no other group uses is generated to be the group ID.

If the desired group ID is transmitted from the mobile terminal device 100, it is checked whether or not the group ID has been already used by the other group or the like. The group ID is defined if the group ID has not been used.

An unused area of the profile information storage unit 210 is ensured as the profile information storage area 220 (Step 22), and the address of the ensured profile information storage area 220 is registered with the profile information management table 204 in the correspondence to the defined group ID (Step 23). At this time, the number of the registration group of the profile information management table 204 is incremented (Step 23). The defined group ID is transmitted to the mobile terminal device 100 which transmitted the registration request of the group (Step 24).

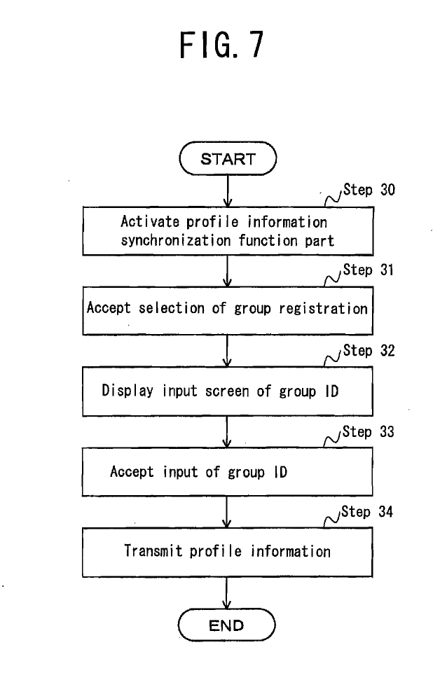

FIG. 7 is a flow chart of profile information registration processing by the mobile terminal device. If the member of the group selects the profile information synchronization function part 110 from the menu screen of his/her mobile terminal device 100, the mobile terminal device 100 activates the profile information synchronization function part 110 (Step 30). Then, the selection of the group registration made by the member is accepted from the profile information synchronization menu (Step 31), the group ID input screen is displayed in the screen of the mobile terminal device 100 (Step 32).

If the group ID inputted by the member is accepted (Step 33), the own profile information which is registered in advance with the mobile terminal device 100, is transmitted with the inputted group ID to the profile information synchronization server 200 (Step 34). As well as the group ID, the own profile information can be inputted from a specific input screen instead of being registered in advance with the mobile terminal device 100.

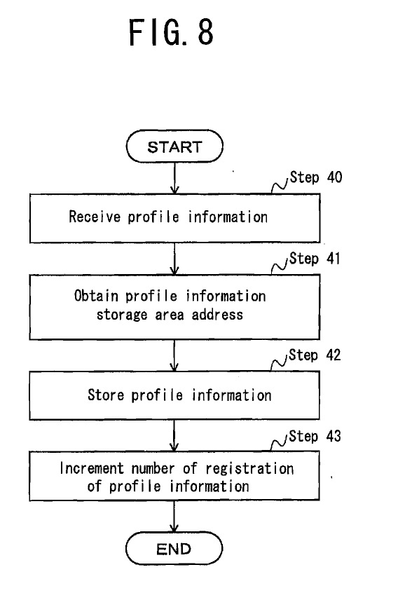

FIG. 8 is a flow chart of profile information storage processing by the profile information synchronization server. When receiving the profile information from the mobile terminal device 100 (Step 40), the profile information synchronization server 200 refers to the profile information management table 204 by the group ID added with the received profile information and obtains the address of the appropriate profile information storage area 220 of the profile information storage unit 210 (Step 41).

The received profile information is stored in the appropriate profile information storage area 220 of the profile information storage unit 210 (Step 42), and the number of registration of the profile information of the group is incremented (Step 43). In this case, the profile information is stored in the appropriate profile information storage area 220 in order that the profile information registration is performed.

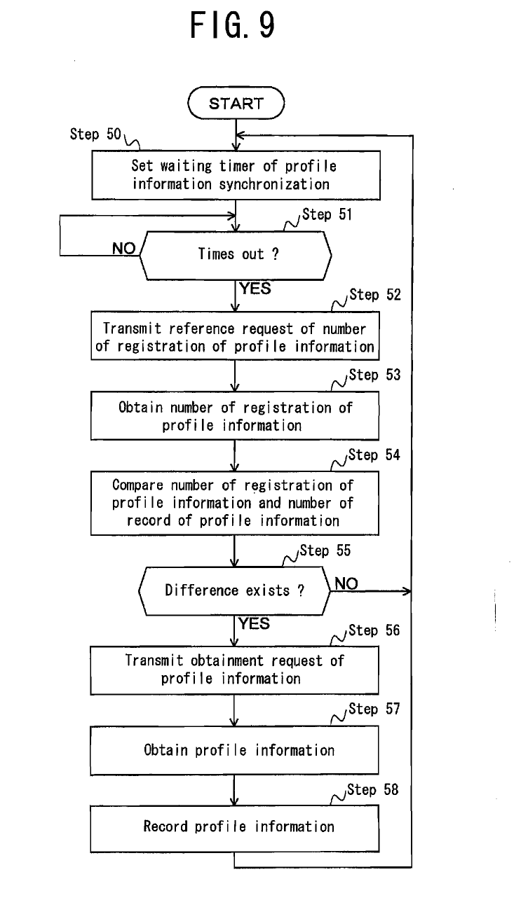

FIG. 9 is a flow chart of profile information obtaining processing by the mobile terminal device. In this case, the profile information obtaining processing shown in FIG.9 is automatically. performed after the profile information registration processing. If the own profile information is registered with the profile information synchronization server 200 by the profile information registration processing, the mobile terminal device 100 sets a waiting timer of the profile information synchronization (Step 50). In this case, the waiting timer of the profile information synchronization times out in 10 minutes. That is, the operation of obtaining the profile information is performed at intervals of 10 minutes.

If the waiting timer of the profile information synchronization times out (Step 51), a reference request of the number of registration of the profile information is transmitted to the profile information synchronization server 200 (Step 52). The reference request of the number of registration of the profile information is added with the group ID. The reference request of the number of registration of the profile information is the request for obtaining, by using the added group ID, the number of the profile information which is registered with the profile information synchronization server 200.

If the number of registration of the profile information is obtained from the profile information synchronization server 200 (Step 53), the obtained number of registration of the profile information is compared to the number of the profile information of the appropriate group ID recorded in the profile information recording unit 114 (Step 54) for calculating the difference. If both of the numbers are the same, that it, there is no difference (Step 55), the process is returned to Step 50. The mobile terminal device 100 goes to a waiting state of the profile information synchronization again.

If the number of record of the profile information is smaller than the number of registration of the profile information, that is, if there is a difference (Step 55), an obtainment request of the profile information including the information indicating the difference and the group ID is transmitted to the profile information synchronization server 200 (Step 56).

The profile information is obtained from the profile information synchronization server 200 (Step 57). New profile information of the appropriate group ID is obtained, for example, only of the number of the difference between the number of registration of the profile information and the number of record of the profile information. The obtained profile information is recorded in the profile information recording unit 114 (Step 58). The process is returned to Step 50 and the mobile terminal device 100 goes to the waiting state of the profile information synchronization again.

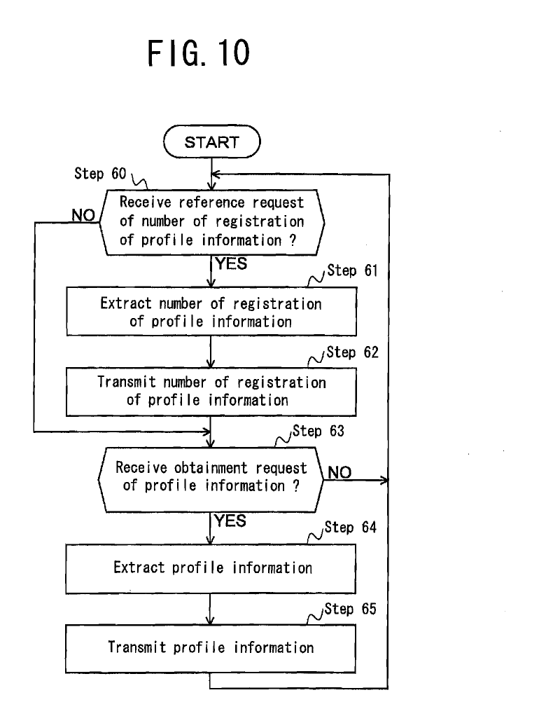

FIG. 10 is a flow chart of profile information synchronization processing by the profile information synchronization server. When receiving the reference request of the number of registration of the profile information from the mobile terminal device 100 (Step 60), the profile information synchronization server 200 extracts the number of registration of the profile information of the appropriate group ID from the profile information storage unit 210 (Step 61). Specifically, the profile information synchronization server 200 refers to the profile information management table 204 by the group ID added with the received reference request of the profile information registration, obtains the address of the appropriate profile information storage area 220, accesses the profile information storage unit 210 by the obtained address and extracts the number of registration of the profile information of the group ID. The obtained number of registration of the profile information is transmitted to the mobile terminal device 100 which transmitted the reference request of the number of registration of the profile information (Step 62).

Also, when receiving an obtainment request of the profile information (Step 63), the profile information synchronization server 200 extracts the profile information of the appropriate group ID from the profile information storage unit 210 (Step 64). Specifically, the profile information synchronization server 200 refers to the profile information management table 204 by the group ID added with the received obtainment request of the profile information, obtains the address of the appropriate profile information storage area 220, accesses the profile information storage unit 210 by the obtained address and extracts the profile information of the appropriate group ID, in order of the newest profile information, of the number specified by the information indicating the difference added with the obtained obtainment request of the profile information. The obtained profile information is transmitted to the mobile terminal device 100 which transmitted the obtainment request of the profile information (Step 65).

In the flow charts shown in FIG.9 and FIG.10, the difference is calculated on a side of the mobile terminal device 100. However, the difference can be calculated on the side of the profile information synchronization server 200. For example, the obtainment request of the profile information including the group ID and the number of record of the profile information can be transmitted to the profile information synchronization server 200 in order to calculate the difference on the side of the profile information synchronization server 200. Then, the new profile information, for example, only of the number of the calculated difference can be transmitted to the mobile terminal device 100.

In the flow charts of FIG. 9 and FIG. 10, the profile information is specified by the difference between the number of record of the profile information of the mobile terminal device 100 and the number of registration of the profile information of the profile information synchronization server 200 and is transmitted to the mobile terminal device 100. However, the embodiments are not limited to such synchronization, and it is possible to apply any method for synchronizing (for example, without limitation, update of existing records, obtaining new records, etc.) the profile information recorded in the mobile terminal device 100 and the profile information registered with the profile information synchronization server 200 by using the group ID. For example, all of the profile information of the appropriate group ID registered with the profile information synchronization server 200 can be transmitted to the mobile terminal device 100 in order to extract unrecorded profile information on the side of the mobile terminal device 100.

In the flow chart shown in FIG.9, the mobile terminal device 100 automatically obtains the profile information from the profile information synchronization server 200. However, the mobile terminal device 100 can access the profile information synchronization server 200 by user operation and obtain the profile information from the profile information synchronization server 200.

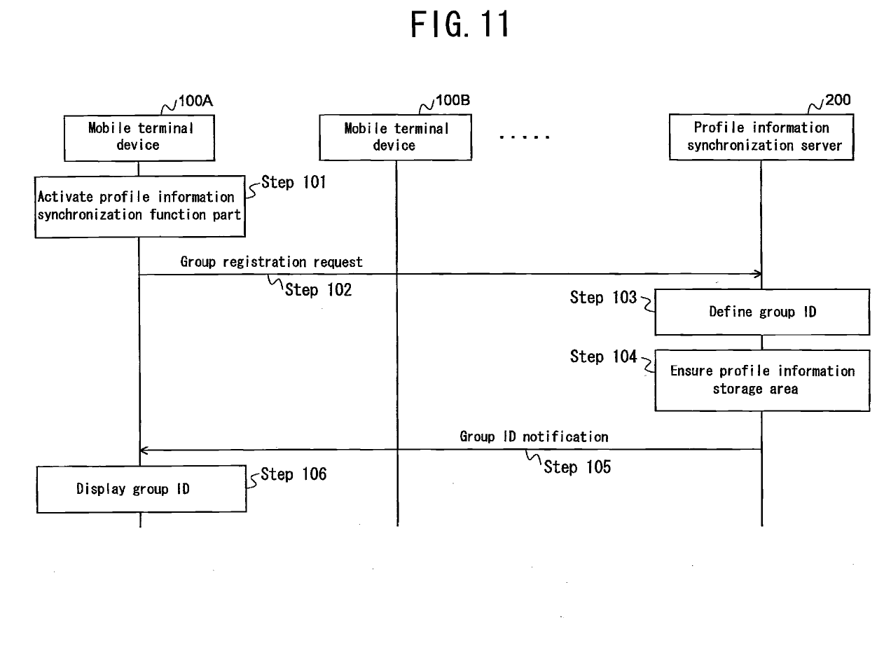

Concrete examples of the profile information synchronization system are explained by using the FIG.11 to FIG.14 as follows. In the below-described example, when a project team is formed, the team members exchange the profile information each other.

FIG. 11 is a diagram (1) explaining the concrete example. Firstly, if a representative member A of the project team selects the profile information synchronization function part from the menu of his/her mobile terminal device 100A, the mobile terminal device 100A activates the profile information synchronization function part (Step 101). Further, if the representative member A selects a new group registration from the menu of the profile information synchronization function part, the mobile terminal device 100A transmits the registration request of the group to the profile information synchronization server 200 (Step 102).

When receiving the registration request of the group, the profile information synchronization server 200 defines the group ID which is to be allocated to the project team (Step 103). This case assumes that “xxxxxx” is defined as the group ID. And, the profile information storage area 220 of the project team is ensured in the profile information storage unit 210 (Step 104). The group ID “xxxxxx” allocated to the project team is transmitted by a group ID notification to the mobile terminal device 100A which the representative member A has (Step 105).

When receiving the group ID “xxxxxx” from the profile information synchronization server 200, the mobile terminal device 100A of the representative member A displays the group ID in the screen (Step 106). The representative member A of the project team notifies the other members of the group ID “xxxxxx”.

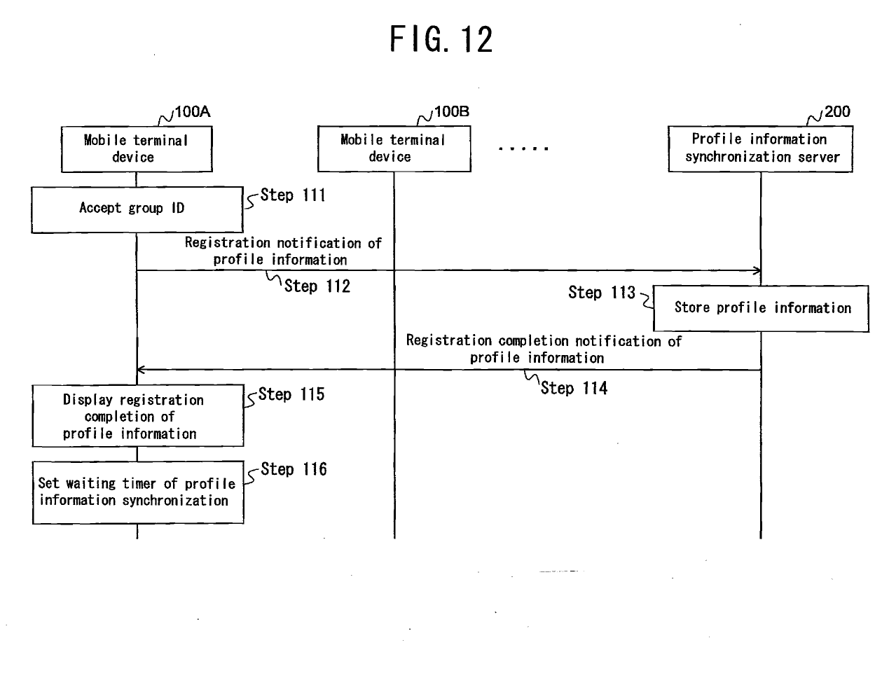

FIG. 12 is a diagram (2) explaining the concrete example. The representative member A registers the profile information with the profile information synchronization server 200. If the representative member A selects the profile information registration from the menu of profile information synchronization function part of the mobile terminal device 100 and inputs the group ID “xxxxxx”, the mobile terminal device 100A accepts the input (Step 111) and transmits a registration notification of the profile information added with the group ID “xxxxxx” inputted to the profile information of the representative member A, which is registered in advance, to the profile information synchronization server 200 (Step 112).

The profile information synchronization server 200 stores the profile information of the received registration notification of the profile information in the profile information storage area 220 of the profile information storage unit 210 which is specified by the group ID “xxxxxx” of the received registration notification of the profile information (Step 113). A registration completion notification of the profile information is transmitted to the mobile terminal device 100A (Step 114).

When receiving the registration completion notification of the profile information, the mobile terminal device 100A displays, in the screen, that the registration of the profile information with the profile information synchronization server 200 is completed (Step 115). Then, the waiting timer of the profile information synchronization is set (Step 116).

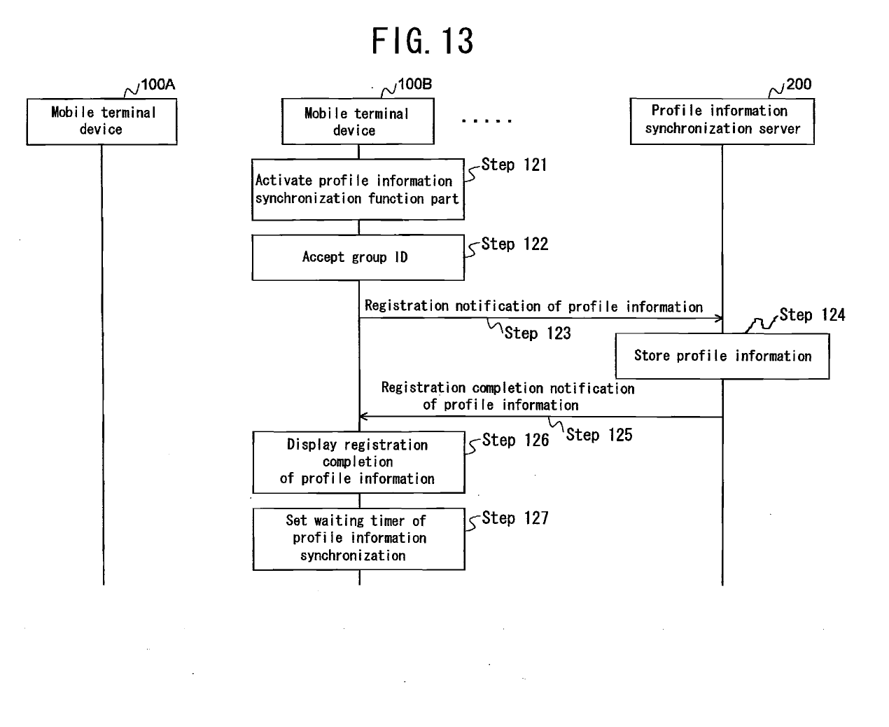

FIG.13 is a diagram (3) explaining the concrete example. Continuously, a member B of the project team registers the profile information. If the member B who is notified of the group ID “xxxxxx” by the representative member A selects the profile information synchronization function part from the menu of his/her mobile terminal device 100B, the mobile terminal device 100B activates the profile information synchronization function part (Step 121).

Further, if the member B selects the profile information registration from the menu of the profile information synchronization function part and inputs the group ID “xxxxxx”, the mobile terminal device 100B accepts the input (Step 122) and transmits the registration notification of the profile information added with the group ID “xxxxxx” inputted to the profile information of the member B, which is registered in advance (Step 123), to the profile information synchronization server 200.

The profile information synchronization server 200 stores the profile information of the received registration notification of the profile information in the profile information storage area 220 of the profile information storage unit 210 which is specified by the group ID “xxxxxx” of the received registration notification of the profile information (Step 124). The registration completion notification of the profile information is transmitted to the mobile terminal device 100B (Step 125).

When receiving the registration completion notification of the profile information, the mobile terminal device 100B displays, in the screen, that the registration of the profile information with the profile information synchronization server 200 is completed (Step 126). Then, the waiting timer of the profile information synchronization is set (Step 127).

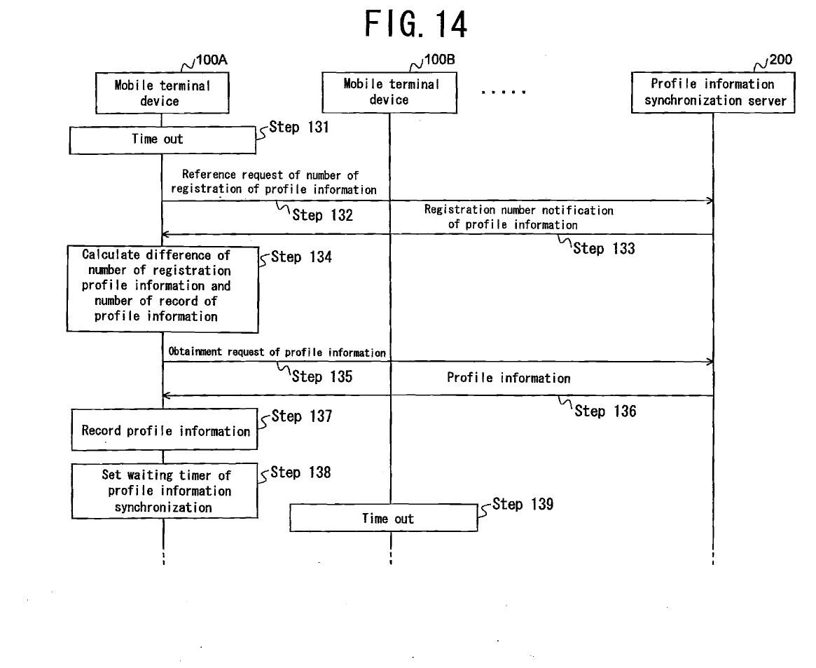

FIG.14 is a diagram (4) explaining the concrete example. The waiting timer of the profile information synchronization of the mobile terminal device 100A times out at this moment. If the time out is detected (Step 131), the mobile terminal device 100A transmits the reference request of the number of registration of the profile information to the profile information synchronization server 200 (Step 132).

The profile information synchronization server 200 reads the number of registration of the profile information from the profile information storage area 220 of the profile information storage unit 210 which is specified by the group ID “xxxxxx” of the reference request of the number of the received profile information, and notifies the mobile terminal device 100A of the number of registration the profile information (Step 133). Since two of the profile information are registered at this moment, “2” is notified as the number of registration of the profile information.

When receiving a registration number notification of the profile information, the mobile terminal device 100A calculates the difference between the number of registration of the profile information and the number of the profile information of the group ID which is recorded in the mobile terminal device 100A itself (Step 134), and transmits the obtainment request of the profile information added with the difference value and the group ID “xxxxxx” to the profile information synchronization server 200 (Step 135). Since no profile information has been obtained in this case, the number of record of the profile information is “0” and the difference value is “2”.

Since the difference value of the obtainment request of the profile information is “2”, the profile information synchronization server 200 obtains two of the profile information, in order of the newest profile information, from the profile information storage area 220 of the profile information storage unit 210 which is specified by the group ID “xxxxxx”, and transmits the two extracted profile information to the mobile terminal device 100A (Step 136). In this case, the profile information of the representative member A and the member B, which are previously registered, are transmitted to the mobile terminal device 100A.

The mobile terminal device 100A records the two received profile information in the profile information recording unit 114 (Step 137). The mobile terminal device 100A again sets the waiting timer of the profile information synchronization (Step 138) and wait until the next time out of the waiting timer of the profile information synchronization.

At this moment, the waiting timer of the profile information synchronization of the mobile terminal device 100B times out. The mobile terminal device 100B as well as the mobile terminal device 100A can obtain the profile information registered in the profile information synchronization server 200 as follows. In the same way, the other members can register the profile information with the profile information synchronization server 200 by the mobile terminal device 100 (figure omitted) by using the group ID “xxxxxx”. The profile information registered in the profile information synchronization server 200 is obtained by all of the mobile terminal devices 100 using the group ID “xxxxxx”.

The embodiments of the present invention are described above. However, the present invention is not limited to these embodiments. In the present embodiment, for example, although the mobile terminal device 100 accesses the profile information synchronization server 200 by using only the group ID, the mobile terminal device 100 can use a password or the like in conjunction with the group ID. This can prevent unauthorized access such as spoofing.

And, for example, the mobile terminal device 100 can access a web site instead of the profile information synchronization server 200. It is possible to access the web site of the profile information synchronization server 200 by the mobile terminal device 100 in order to input the group ID and the profile information to the screen of the web site, and to transmit the group ID and the profile information to the profile information synchronization server 200.

The embodiments can be implemented in computing hardware (computing apparatus) and/or software, such as (in an unlimiting example) any computer that can store, retrieve, process and/or output data and/or communicate with other computers. The computer (e.g., the mobile terminal device, the profile information synchronization server, etc.) comprises a controller (CPU) and a display device. The results produced can be displayed on a display of the computing hardware. A program/software implementing the embodiments may be recorded on computer-readable media comprising computer-readable recording media. The program/software implementing the embodiments may also be transmitted over a transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. Examples of transmission communication media include a carrier-wave signal, an optical signal, etc. Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A profile information synchronization system, comprising:
a plurality of mobile terminal devices; and
a profile information synchronization server in communication with the plurality of mobile terminal devices and comprising:
a profile information storage unit storing profile information of a user registered by the mobile terminal device for each group identification information identifying a group of users exchanging the profile information between the mobile terminal devices, and
a controller
storing in the profile information storage unit profile information of the user received from the mobile terminal device in correspondence to the group identification information,
extracting, based upon the group identification information, one or more of the profile information of the group to which the user of the mobile terminal device belongs including new profile information that the mobile terminal device has not recorded, from the profile information storage unit, and
transmitting the extracted profile information to the mobile terminal device,
wherein the mobile terminal devices comprises a controller
transmitting the profile information of the user of the mobile terminal device along with the group identification information to the profile information synchronization server;
obtaining from the profile information synchronization server the extracted profile information of the group to which the user of the mobile terminal device belongs including the new profile information that the mobile terminal device itself has not recorded, based upon the group identification information; and
recording the obtained profile information.

2. The profile information synchronization system according to claim 1, wherein the obtaining of the profile information by the mobile terminal device comprises automatically accessing the profile information synchronization server at intervals of a predetermined time and obtaining the profile information of the group to which the user belongs including the new profile information, based upon the group identification information.

3. A method synchronizing profile information of mobile terminal devices of users, comprising:
transmitting profile information of a user of a mobile terminal device along with a group identification information to a profile information synchronization server;
registering by the profile information synchronization server received profile information in correspondence with received group identification information, based upon the transmitting;
extracting by the profile information synchronization server one or more of the profile information managed based upon the received group identification information of the group to which the user of the mobile terminal device belongs including new profile information that the mobile terminal device has not recorded and transmitting the extracted profile information to the mobile terminal device; and
obtaining by the mobile terminal device the profile information of the group to which the user of the mobile terminal device belongs including the new profile information that the mobile terminal device itself has not recorded, from the profile information synchronization server based upon the group identification information.

4. The profile information synchronization method according to claim 3, wherein the obtaining of the profile information by the mobile terminal device comprises automatically accessing the profile information synchronization server at intervals of a predetermined time and obtaining the profile information of the group to which the user belongs including the new profile information, based upon the group identification information.

5. A mobile terminal device in communication with a profile information synchronization server having a profile information storage device storing profile information of a user registered by the mobile terminal device according to group identification information identifying a group of users exchanging the profile information between mobile terminal devices, comprising:
a management unit transmitting the profile information of the user of the mobile terminal device to the profile information synchronization server along with the group identification information for registration by the profile information synchronization server storing the profile information of the user of the mobile terminal device received with the group identification information in correspondence with the group identification information for management;
an obtaining unit receiving the profile information of the group to which the user of the mobile terminal device belongs from the profile information synchronization server including new profile information that the mobile terminal device itself has not recorded; and
a storage unit storing the obtained profile information.

6. The mobile terminal device according to claim 5, wherein the obtaining unit obtaining the profile information of the mobile terminal device automatically accesses the profile information synchronization server at intervals of a predetermined time and obtains the profile information of the group to which the user belongs including the new profile information that the mobile terminal device itself has not recorded, from the profile information managed by the profile information synchronization server based upon the group identification information.

7. A profile information synchronization server in communication with a plurality of mobile terminal devices having a storage unit storing profile information, comprising:
a profile information storage device storing profile information of a user registered by a mobile terminal device according to group identification information identifying a group of users exchanging the profile information between the mobile terminal devices,
a management unit receiving the profile information of the user with the group identification information from the mobile terminal device, and storing the received profile information in the profile information storage device in correspondence to the group identification information;
a transmitting unit extracting, from the profile information storage device, one or more of the profile information managed based upon the group identification information of the group to which the user of the mobile terminal device belongs including new profile information that the mobile terminal device has not recorded, and transmitting the extracted profile information to the mobile terminal device.

8. The method according to claim 3, further comprising prompting, by the mobile terminal device, user input of the group identification information.
